(19) United States
(12) Patent Application Publication
(10) Pub. No.: US 2023/0295041 A1
(43) Pub. Date: Sep. 21, 2023

(54) FIRE RESISTANT GYPSUM PANELS, AND METHODS

(71) Applicant: Georgia-Pacific Gypsum LLC, Atlanta, GA (US)

(72) Inventors: Fabio Enrique ESGUERRA, Covington, GA (US); Allison N. GOINS, Marietta, GA (US); Anne H. KSIONZYK, Decatur, GA (US); Christopher J. SANDERS, Southaven, MS (US); Bryan J. WILTZIUS, Atlanta, GA (US)

(21) Appl. No.: 18/016,873

(22) PCT Filed: Jul. 30, 2021
(86) PCT No.: PCT/IB2021/056994

§ 371 Date: Jan. 19, 2023

Related U.S. Application Data
(60) Provisional application No. 63/062,534, filed on Aug. 7, 2020.

(51) Int. Cl. C04B 11/26; C04B 14/10; C04B 14/06

(52) U.S. Cl. CPC C04B 11/266; C04B 14/10; C04B 14/06; C04B 2111/28

(57) ABSTRACT

Fire resistant gypsum panels are provided herein, with assemblies including the same, and methods for making the same. A gypsum panel includes a set gypsum core and a mat facing material. The set gypsum core includes a fire resistant additive. The fire resistant additive consists essentially of clay, or a non-intumescent fire resistant additive. The panel displays an acceptable fire rating without requiring the use of vermiculite or intumescent materials.

### BACKGROUND

The present invention relates generally to the field of panels for use in building construction, and more particularly to gypsum panels and methods of making gypsum panels.

Typical building panels, such as interior building panels, building sheathing, or roof panels, include a core material, such as gypsum, and a mat facer, such as a paper facer or fiberglass mat facer. During manufacturing, the gypsum core material is traditionally applied as a slurry to a surface of the mat facer and allowed to set, such that the mat facer and gypsum core are adhered at the interface. Conventionally, such panels are heavy—with weights above 2000 lbs/msf—and lighter panels may suffer from performance issues and/or require costly ingredients to achieve certain properties (e.g., physical properties and fire resistance).

WO2014/187703 discloses fire resistant calcium sulfate-based products comprising gypsum and a clay additive at a dosage above 22 weight percent.

However, it would be desirable to provide relatively lightweight panels while maintaining necessary physical properties and fire resistance.

### SUMMARY

In one aspect, a gypsum panel is provided, including a set gypsum core and a mat facing material. The set gypsum core includes a fire resistant additive. The fire resistant additive consists essentially of clay. The clay is present in the set gypsum core in an amount of from about 0.5 to about 15 weight percent. The mat facing material is associated with a surface of the set gypsum core. The panel displays a fire rating of not less than one hour when constructed as according to ASTM C1396 and tested in accordance with ASTM Test Method E119: Standard Test Methods for Fire Tests of Building Construction and Materials.

In another aspect, a gypsum panel is provided, including a set gypsum core and a mat facing material. The set gypsum core includes clay in the absence of any non-clay fire resistant additives present in an amount effective to alter the fire resistance performance of the panel. The mat facing material is associated with a surface of the set gypsum core. The panel displays a fire rating not less than one hour when constructed as according to ASTM C1396 and tested in accordance with ASTM Test Method E119: Standard Test Methods for Fire Tests of Building Construction and Materials.

In yet another aspect, a gypsum panel is provided, including a set gypsum core and a mat facing material. The set gypsum core includes a non-intumescent fire resistant additive. The non-intumescent fire resistant additive includes silica in an amount of at least 40% by weight of the non-intumescent fire resistant additive. The non-intumescent fire resistant additive includes ceramic flux agent in a total amount of more than 0% by weight and less than or equal to 5% by weight of the non-intumescent fire resistant additive. The mat facing material is associated with a surface of the set gypsum core.

Methods for making gypsum panels, and building assemblies including gypsum panels are also provided.

### BRIEF DESCRIPTION OF THE DRAWINGS

The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a cross-sectional view of a gypsum panel.

FIG. 2 is a cross-sectional view of a gypsum panel

FIG. 3 is a cross-sectional view of a gypsum panel.

FIG. 4 is a graph showing the % volume expansion of various experimental samples subjected to a high temperature volume expansion test, according to the Examples.

FIG. 5 is a graph showing the dilatometer volume shrinkage of various experimental samples subjected to high temperature, according to the Examples.

FIG. 6 is a graph showing the % shrinkage of various experimental samples subjected to a high temperature thermal shrinkage (diameter) test, according to the Examples.

FIG. 7 is a graph showing the % shrinkage of various experimental samples subjected to a high temperature thermal shrinkage (thickness) test, according to the Examples.

FIG. 8 is a graph showing the time of thermal transmission of various experimental samples subjected to a thermal transmission test, according to the Examples.

FIG. 9 is a graph showing the % volume expansion of various experimental samples subjected to a high temperature volume expansion test, according to the Examples.

FIG. 10 is a graph showing the % shrinkage of various experimental samples subjected to a high temperature thermal shrinkage (volume) test, according to the Examples.

FIG. 11 is a graph showing a magnified portion of the graph of FIG. 10, according to the Examples.

### DETAILED DESCRIPTION

Gypsum panels and systems of panels, and methods for their manufacture, are provided herein. The panels may be relatively lightweight panels and display improved fire resistance and physical properties, such as resistance to deflection and expansion. In particular, these panels contain a fire resistant additive that is clay, in a relatively low amount.

It has been discovered that clay materials provide effective fire resistance properties to gypsum panels as a standalone fire resistant additive, i.e., in the absence of other fire resistant additives, even when provided in relatively low amounts previously believed to be lower than the necessary threshold to achieve fire resistant properties and/or previously used only in combination with further fire resistant additives.

It has also been discovered that non-intumescent fire resistant additives including at least 40% silica and less than 2% of a ceramic flux agent provide effective fire resistance properties to gypsum panels as a standalone fire resistant additive, i.e., in the absence of other fire resistant additives, even when provided in relatively low amounts previously believed to be lower than the necessary threshold to achieve fire resistant properties and/or previously used only in combination with further fire resistant additives.

As used herein, the terms “fire resistant,” “fire resistance,” and similar terms, when used in reference to additives or materials used for imparting properties to the gypsum panel refer to additives that improve fire resistance, including at and above temperatures from 800° C., but that do not materially improve the structural properties of the gypsum panel. For example, fiberglass may improve both the structural and fire resistant properties of a gypsum panel; however, fiberglass does not contribute to fire resistance above 800° C. For example, phyllosilicates, such as vermiculate and perlite, improve the fire resistant properties but do not materially improve the structural properties.

The panels described herein contain clay as the sole constituent fire resistant additive. That is, clay may be the sole fire resistant additive intentionally to the gypsum slurry in an amount effective to materially alter the fire resistance performance of the panel. It should be understood that other fire resistant additive materials may be present in contamination or trace amounts, such as through the use of impure recycled materials (e.g., gypsum stucco) containing remnants of such materials. For example, in certain embodiments, non-clay fire resistant additives may be present in amounts of 0.25 weight percent or lower.

For example, the use of clay as the sole fire resistant additive in a gypsum panel has been found to provide improved fire resistance performance, while allowing for low-density panels without the use of volumetric expansion to combat panel deflection that is associated with certain know fire resistant additives, such as phyllosilicates and other materials with high coefficients of thermal expansion. In particular, the gypsum panels described herein may beneficially provide an alternative to the use of vermiculite in gypsum panels to achieve necessary fire resistance for products with fire ratings.

Generally, this disclosure relates to the use of clay materials to achieve fire resistant gypsum panels. Throughout the disclosure, clay materials refer to known types of clay, including bentonite clays—comprised mainly of the clay mineral montmorillonite; attapulgite clays—clays which contain magnesium aluminum silicates; and kaolinitic clays—including for example, kaolin (also referred to as China or paper clays), ball clay, fireclay, and flint clay, which clays are comprised predominately of the clay mineral kaolinite. Other of the various types of clays that contain mixtures of various proportions of clay minerals, such as for example illite, chlorite, kaolinite and montmorillonite, may also be used. In certain embodiments, the fire resistant additive is limited to kaolinitic clays. Generally, the clays may be utilized in calcined or uncalcined forms.

As described herein, the clay materials may be the only constituent component in the gypsum panel present solely to provide fire resistant properties. This disclosure also relates to the use of non-intumescent fire resistant additives having high silica and low ceramic flux agent, for example, 40% or more by weight of silica, and 2% or less by weight of ceramic flux agent. As described herein, the non-intumescent fire resistant additives may be the only constituent component in the gypsum panel present solely to provide fire resistant properties.

That is, the gypsum panel core and slurry composition(s) that it is formed of may be devoid of other materials that traditionally are used exclusively to impart fire resistant properties to the panel. For example, the panels described herein may utilize clay or a non-intumescent low-flux high silica additive as the sole fire resistant additive in the panel core, and the panel core may not contain material amounts of any other fire resistant additive, such as vermiculite, calcium sulfate whisker fibers, colloidal silica, colloidal alumina, perlite, wollastonite, mica, graphite, or diatomaceous earth. In particular, the panels described herein may not contain any materials with high coefficients of thermal expansion.

Generally, this disclosure is intended to encompass various forms of gypsum panel products, such as paper-faced fire-rated panels, sheathing panels, roofing panels, and other glass mat and paper faced gypsum panels. While certain embodiments may be described with reference to the term “fire-rated” “sheathing” or “roofing”, it should be understood that the panels described herein are not meant to be limited to these particular uses, and that the features of panels described as fire-rated, sheathing or roofing panels may be encompassed by other types of gypsum panels.

Gypsum panels or boards may contain a set gypsum core sandwiched between two mats, none, one, or both of which may be coated. The mat coating may be a substantially continuous barrier coating. As used herein, the term “substantially continuous barrier coating” refers to a coating material that is substantially uninterrupted over the surface of the mat.

During manufacturing, a gypsum slurry may be deposited on the uncoated surface of a facer material, such as a paper sheet or fibrous mat (which may be pre-coated offline or online), and set to form a gypsum core of the panel. The gypsum slurry may adhere to a paper facing material or penetrate some portion of the thickness of the fiberglass mat, and provide a mechanical bond for the panel. The gypsum slurry may be provided in one or more layers, having the same or different compositions, including one or more slate coat layers. As used herein, the term “slate coat” refers to a gypsum slurry having a higher wet density than the remainder of the gypsum slurry that forms the gypsum core.

While embodiments of the present disclosure are described generally with reference to paper facing materials or fiberglass mats, it should be understood that other mat materials, including other fibrous mat materials, may also be used in the present panels. In certain embodiments, the nonwoven fibrous mat is formed of fiber material that is capable of forming a strong bond with the material of the building panel core through a mechanical-like interlocking between the interstices of the fibrous mat and portions of the core material. Examples of fiber materials for use in the nonwoven mats include mineral-type materials such as glass fibers, synthetic resin fibers, and mixtures or blends thereof. Both chopped strands and continuous strands may be used.

Various embodiments of this disclosure are for purposes of illustration only. Parameters of different steps, components, and features of the embodiments are described separately, but may be combined consistently with this description of claims, to enable other embodiments as well to be understood by those skilled in the art. Various terms used herein are likewise defined in the description of gypsum panels and methods for their manufacture, which follows.

Methods

Methods of making gypsum panels containing a fire resistant additive that is a clay material are provided. In particular, these methods may include (i) forming a first gypsum slurry by combining stucco, water, and the fire resistant additive that is one or more clay materials, (ii) setting the first gypsum slurry to form at least part of a core of the gypsum panel, and (iii) associating a mat facing material with a surface of the set gypsum core. In certain embodiments, as described herein, associating a mat facing material with the gypsum core involves associated the mat facing material with the gypsum slurry prior to setting.

The clay material may be any suitable clay material, or combination of clay materials, described herein. In one embodiment, the clay is uncalcined kaolin, calcined kaolin, fire clay, ball clay, or a combination thereof. In certain embodiments, the clay is kaolin.

The one or more clay materials may be present in the set gypsum core in a relatively low amount, such as from about 0.5 to about 15 weight percent, from about 1 to about 10 weight percent, or from about 1.5 to about 6 weight percent, of the set gypsum core. In certain embodiments, the clay material is present in the set gypsum core in an amount of from about 30 to about 110 lb/msf, or lower, for a gypsum panel having a thickness of about ¼ inch to about 1 inch. As used herein, “msf” refers to 1,000 square feet. In certain embodiments, the clay material may be present in the gypsum core in an amount greater than any other component, other than the gypsum.

Methods of making gypsum panels containing a non-intumescent fire resistant additive are provided. In particular, these methods may include (i) forming a first gypsum slurry by combining stucco, water, and the non-intumescent fire resistant additive, (ii) setting the first gypsum slurry to form at least part of a core of the gypsum panel, and (iii) associating a mat facing material with a surface of the set gypsum core. In certain embodiments, as described herein, associating a mat facing material with the gypsum core involves associated the mat facing material with the gypsum slurry prior to setting. The non-intumescent fire resistant additive includes silica in an amount of at least 40% by weight of the non-intumescent fire resistant additive, and ceramic flux agent in a total amount of more than 0% by weight and less than or equal to 5% by weight of the non-intumescent fire resistant additive. In some embodiments, the ceramic flux agent in a total amount of less than or equal to 2% by weight of the non-intumescent fire resistant additive.

The panel thickness ranges given herein are meant to be exemplary, and it should be understood that panels in accordance with the present disclosure may have any suitable thickness. Where amounts of materials present within the panel are defined in terms of lb/msf over a certain thickness of panel, it should be understood that the amount of the relevant material described to be present per volume of the panel may be applied to various other panel thicknesses. In certain embodiments, the panels have a thickness from about ¼ inch to about 1 inch. For example, the panels may have a thickness of from about ½ inch to about ⅝ inch, such as from about ½ inch to about ¾, as generally described. As used herein the term “about” is used to refer to plus or minus 2 percent of the relevant numeral that it describes.

These methods may be used to produce gypsum panels having any of the features, or combinations of features, described herein, such as improved physical properties, such as resistance to expansion and deflection, and fire resistance. Moreover, the methods may be used to produce relatively lightweight gypsum panels. For example, the panels described herein may display one or more of the following properties: a fire rating of equal to or greater than 60 minutes when measured according ASTM E119 or equivalent testing standards, an average volume shrinkage of 5% or less at temperatures up to 927° C., an average thickness thermal shrinkage of 20% or less at temperatures up to 927° C. Additionally, the panels may have a relatively low density, as low as 30 lb/ft³ (pcf), such as less than 40 pcf, or less than 35 pcf, for example from 30 pcf to 45 pcf, or from 30 pcf to 40 pcf, while maintaining these fire performance and structural properties.

In certain embodiments, the gypsum slurries of the present disclosure further contain one or more ingredients or additives to achieve the desired board properties. Various additives are discussed herein and may be used in any combination. In particular, suitable additives may include, but are not limited to, one or more of reinforcing fibers, starch, dispersants, ball mill accelerators, retarders, potash, and polymer binders.

In certain embodiments, one or more layers of the gypsum core also include structural reinforcing fibers, such as chopped glass fibers. As discussed herein, fiberglass may improve both the structural and fire resistant properties of a gypsum panel; however, fiberglass does not contribute to fire resistance above 800° C. For example, the gypsum core, or any layer(s) thereof, may include up to about 0.6 pounds of reinforcing fibers per 100 square feet of panel. For example, the gypsum core, or a layer thereof, may include about 0.3 pounds of reinforcing fibers per 100 square feet of panel. The reinforcing fibers may have a diameter between about 10 and about 17 microns and have a length between about 6.35 and about 12.7 millimeters.

For example, a suitable starch may be contained in the gypsum slurry. The starch may be any suitable starch material known in the industry. In some embodiments, the starch is pregelatinized (precooked) starch or a combination of uncooked and pregelatinized starch. For example, the starch may be present in the gypsum core in an amount of about 1 lb/msf to about 70 lb/msf, for a gypsum panel having a thickness of about ¼ inch to about 1 inch, such as from about 1 lb/msf to about 50 lb/msf.

For example, a suitable polymer binder, such as an organic polymer binder may be contained in the gypsum slurry. Suitable polymer binders may include polymeric emulsions and resins, e.g., acrylics, siloxane, silicone, styrene-butadiene copolymers, polyethylene-vinyl acetate, polyvinyl alcohol, polyvinyl chloride (PVC), polyurethane, urea-formaldehyde resin, phenolics resin, polyvinyl butyryl, styrene-acrylic copolymers, styrene-vinyl-acrylic copolymers, styrene-maleic anhydride copolymers. In some embodiments, the binders may include UV curable monomers and polymers (e.g., epoxy acrylate, urethane acrylate, polyester acrylate). For example, on a dry basis, the polymer binder content may be between 1 lb/msf to 50 lb/msf, for a gypsum panel having a thickness of about ¼ inch to 1 inch.

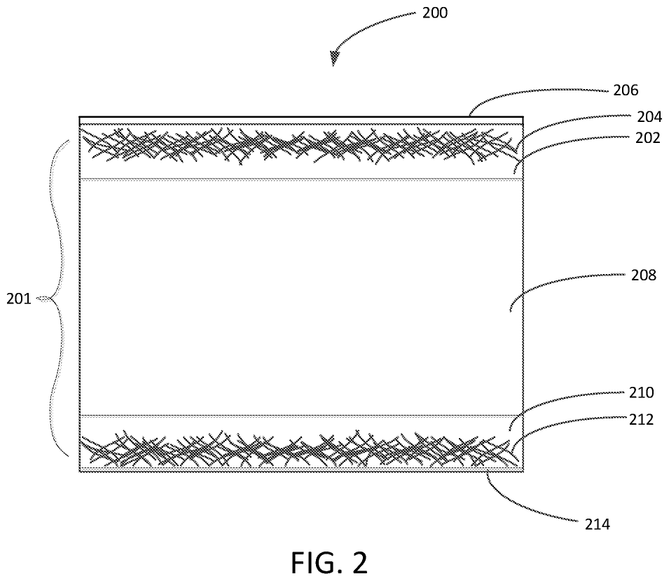

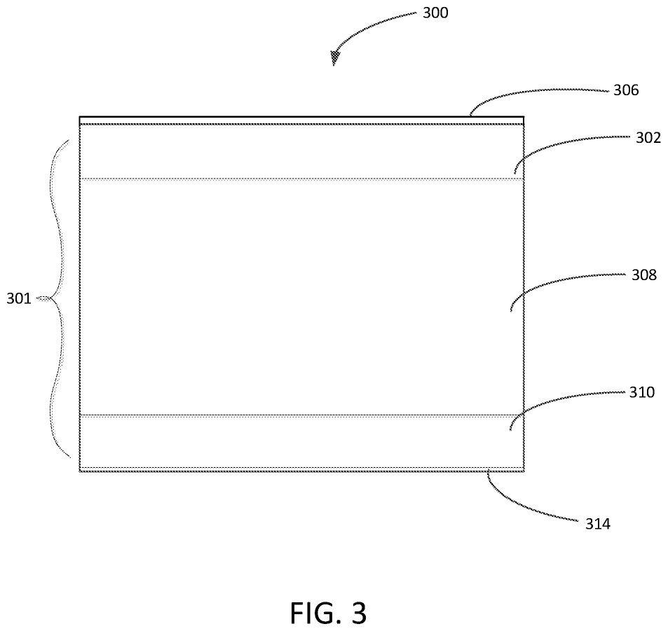

In certain embodiments, the gypsum core includes multiple layers that are sequentially applied to a facing material, and allowed to set either sequentially or simultaneously. In such embodiments, the first gypsum slurry may form any one or more of these layers. In other embodiments, the gypsum core includes a single layer formed by the first gypsum slurry. In some embodiments, a second facing material may be deposited onto a surface of the final gypsum slurry layer (or the sole gypsum slurry layer), to form a dual mat-faced gypsum panel, as shown in FIGS. 2 and 3. In certain embodiments, the first gypsum slurry (or each of the outermost gypsum slurry layers) is deposited in an amount of from about 5 percent to about 20 percent, by weight, of the gypsum core. The gypsum slurry or multiple layers thereof may be deposited on the facer material by any suitable means, such as roll coating.

In certain embodiments, the first gypsum slurry (or other gypsum slurry layers that form the core) contains one or more additional agents to enhance its performance, such as, but not limited to, wetting agents, fillers, accelerators, set retarders, foaming agents, and dispersing agents. Various example uses of such further additives will now be described.

In certain embodiments, a wetting agent is selected from a group consisting of surfactants, superplasticisers, dispersants, agents containing surfactants, agents containing superplasticisers, agents containing dispersants, and combinations thereof. For example, the gypsum slurry or layer(s) may include wax, wax emulsions and co-emulsions, silicone, siloxane, siliconate, or a combination thereof. For example, suitable superplasticisers include Melflux 2651 F and 4930F, commercially available from BASF Corporation. In certain embodiments, the wetting agent is a surfactant having a boiling point of 200° C. or lower. In some embodiments, the surfactant has a boiling point of 150° C. or lower. In some embodiments, the surfactant has a boiling point of 110° C. or lower. For example, the surfactant may be a multifunctional agent based on acetylenic chemistry or an ethoxylated low-foam agent.

In certain embodiments, a surfactant is present in the relevant gypsum slurry in an amount of about 0.01 percent to about 1 percent, by weight. In certain embodiments, the surfactant is present in the relevant gypsum slurry in an amount of about 0.01 percent to about 0.5 percent, by weight. In some embodiments, the surfactant is present in the relevant gypsum slurry in an amount of about 0.05 percent to about 0.2 percent, by weight.

Suitable surfactants and other wetting agents may be selected from non-ionic, anionic, cationic, or zwitterionic compounds, such as alkyl sulfates, ammonium lauryl sulfate, sodium lauryl sulfate, alkyl-ether sulfates, sodium laureth sulfate, sodium myreth sulfate, docusates, dioctyl sodium sulfosuccinate, perfluorooctanesulfonate, perfluorobutanesulfonate, linear alkylbenzene sulfonates, alkyl-aryl ether phosphates, alkyl ether phosphate, alkyl carboxylates, sodium stearate, sodium lauroyl sarcosinate, carboxylate-based fluorosurfactants, perfluorononanoate, perfluorooctanoate, amines, octenidine dihydrochloride, alkyltrimethylammonium salts, cetyl trimethylammonium bromide, cetyl trimethylammonium chloride, cetylpyridinium chloride, benzalkonium chloride, benzethonium chloride, 5-Bromo-5-nitro-1,3-dioxane, dimethyldioctadecylammonium chloride, cetrimonium bromide, dioctadecyldimethylammonium bromide, sultaines, cocamidopropyl hydroxysultaine, betaines, cocamidopropyl betaine, phospholipids phosphatidylserine, phosphatidylethanolamine, phosphatidylcholine, sphingomyelins, fatty alcohols, cetyl alcohol, stearyl alcohol, cetostearyl alcohol, stearyl alcohols, oleyl alcohol, polyoxyethylene glycol alkyl ethers, octaethylene glycol monododecyl ether, pentaethylene glycol monododecyl ether, polyoxypropylene glycol alkyl ethers, glucoside alkyl ethers, polyoxyethylene glycol octylphenol ethers, polyoxyethylene glycol alkylphenol ethers, glycerol alkyl esters, polyoxyethylene glycol sorbitan alkyl esters, sorbitan alkyl esters, cocamide MEA, cocamide DEA, dodecyldimethylamine oxide, polyethoxylated tallow amine, and block copolymers of polyethylene glycol and polypropylene glycol. For example, suitable surfactants include Surfynol 61, commercially available from Air Products and Chemicals, Inc. (Allentown, PA).

In certain embodiments, the gypsum slurry (or one or more layers thereof) is substantially free of foam, honeycomb, excess water, and micelle formations. As used herein, the term “substantially free” refers to the slurry containing lower than an amount of these materials that would materially affect the performance of the panel. That is, these materials are not present in the slurry in an amount that would result in the formation of pathways for liquid water in the glass mat of a set panel, when under pressure.

In certain embodiments, the panel core slurry (or layers thereof) may be deposited on a horizontally oriented moving web of facer material, such as pre-coated fibrous mat or paper facing material. A second coated or uncoated web of facer material may be deposited onto the surface of the panel core slurry opposite the first web of facer material, e.g., a non-coated surface of the second web of facer material contacts the panel core slurry. In some embodiments, a moving web of a facer material may be placed on the upper free surface of the aqueous panel core slurry. Thus, the panel core material may be sandwiched between two facer materials, none, one or both having a coating. In certain embodiments, allowing the panel core material and/or coating to set includes curing, drying, such as in an oven or by another suitable drying mechanism, or allowing the material(s) to set at room temperature (i.e., to self-harden).

A barrier coating may be applied to one or both (in embodiments having two) facer surfaces, prior to or after drying of the facers. In some embodiments, the glass mats are pre-coated when they are associated with the panel core slurry. In some embodiments, depositing a barrier coating onto the second surface of the first coated glass mat occurs after setting the first gypsum slurry to form at least a portion of a gypsum core. In some embodiments, the gypsum core coated with the barrier coating is cured, dried, such as in an oven or by another suitable drying mechanism, or the materials are allowed to set at room temperature. In some embodiment, infrared heating is used to flash off water and dry the barrier coating.

Suitable coating materials (i.e., the precursor to the dried mat coating) may contain at least one suitable polymer binder. Suitable polymer binders may be selected from polymeric emulsions and resins, e.g. acrylics, siloxane, silicone, styrene-butadiene copolymers, polyethylene-vinyl acetate, polyvinyl alcohol, polyvinyl chloride (PVC), polyurethane, urea-formaldehyde resin, phenolics resin, polyvinyl butyryl, styrene-acrylic copolymers, styrene-vinyl-acrylic copolymers, styrene-maleic anhydride copolymers. In some embodiments, the polymer binder is an acrylic latex or a polystyrene latex. In some embodiments, the polymer binder is hydrophobic. In certain embodiments, the binder includes UV curable monomers and/or polymers (e.g. epoxy acrylate, urethane acrylate, polyester acrylate). In certain embodiments, the mat coating contains the polymer binder in an amount of from about 5 percent to about 75 percent, by weight, on a dry basis.

Examples of suitable polymer binders that may be used in the continuous barrier coatings described herein include SNAP 720, commercially available from Arkema Coating Resins, which is a structured nano-particle acrylic polymer containing 100% acrylic latex and 49% solids by weight, with a 0.08 micron particle size; SNAP 728, commercially available from Arkema Coating Resins, which is a structured nano-acrylic polymer containing 100% acrylic latex and 49% solids by weight, with a 0.1 micron particle size; and NEOCAR 820, commercially available from Arkema Coating Reins, which is a hydrophobic modified acrylic latex containing 45% solids by weight, with a 0.07 micron particle size.

In certain embodiments, the mat coating also contains one or more inorganic fillers. For example, the inorganic filler may be calcium carbonate or another suitable filler known in the industry. In certain embodiments, the filler is an inorganic mineral filler, such as ground limestone (calcium carbonate), clay, mica, gypsum (calcium sulfate dihydrate), aluminum trihydrate (ATH), antimony oxide, sodium-potassium alumina silicates, pyrophyllite, microcrystalline silica, and talc (magnesium silicate). In certain embodiments, the filler may inherently contain a naturally occurring inorganic adhesive binder. For example, the filler may be limestone containing quicklime (CaO), clay containing calcium silicate, sand containing calcium silicate, aluminum trihydrate containing aluminum hydroxide, cementitious fly ash, or magnesium oxide containing either the sulfate or chloride of magnesium, or both. In certain embodiments, the filler may include an inorganic adhesive binder as a constituent, cure by hydration, and act as a flame suppressant. For example, the filler may be aluminum trihydrate (ATH), calcium sulfate (gypsum), and the oxychloride and oxysulfate of magnesium. For example, fillers may include MINEX 7, commercially available from the Cary Company (Addison, IL); IMSIL A-10, commercially available from the Cary Company; and TALCRON MP 44-26, commercially available from Specialty Minerals Inc. (Dillon, MT). The filler may be in a particulate form. For example, the filler may have a particle size such that at least 95% of the particles pass through a 100 mesh wire screen.

In certain embodiments, the precursor material that forms the mat coating also contains water. For example, the coating material may contain the polymer binder in an amount of from about 35 percent to about 80 percent, by weight, and water in an amount of from about 20 percent to about 30 percent, by weight. In embodiments containing the filler, the continuous barrier coating material may also contain an inorganic filler in an amount of from about 35 percent to about 80 percent, by weight. In some embodiments, the polymer binder and the inorganic filler are present in amounts of within 5 percent, by weight, of each other. For example, the polymer binder and filler may be present in a ratio of approximately 1:1.

In some embodiments, the mat coating also includes water and/or other optional ingredients such as colorants (e.g., dyes or pigments), transfer agents, thickeners or rheological control agents, surfactants, ammonia compositions, defoamers, dispersants, biocides, UV absorbers, and preservatives. Thickeners may include hydroxyethyl cellulose; hydrophobically modified ethylene oxide urethane; processed attapulgite, a hydrated magnesium aluminosilicate; and other thickeners known to those of ordinary skill in the art. For example, thickeners may include CELLOSIZE QP-09-L and ACRYSOL RM-2020NPR, commercially available from Dow Chemical Company (Philadelphia, PA); and ATTAGEL 50, commercially available from BASF Corporation (Florham Park, NJ). Surfactants may include sodium polyacrylate dispersants, ethoxylated nonionic compounds, and other surfactants known to those of ordinary skill in the art. For example, surfactants may include HYDROPALAT 44, commercially available from BASF Corporation; and DYNOL 607, commercially available from Air Products (Allentown, PA). Defoamers may include multi-hydrophobe blend defoamers and other defoamers known to those of ordinary skill in the art. For example, defoamers may include FOAMASTER SA-3, commercially available from BASF Corporation. Ammonia compositions may include ammonium hydroxide, for example, AQUA AMMONIA 26 BE, commercially available from Tanner Industries, Inc. (Southampton, PA). Biocides may include broad-spectrum microbicides that prohibit bacteria and fungi growth, antimicrobials such as those based on the active diiodomethyl-p-tolylsulfone, and other compounds known to those of ordinary skill in the art. For example, biocides may include KATHON LX 1.5%, commercially available from Dow Chemical Company, POLYPHASE 663, commercially available from Troy Corporation (Newark, NJ), and AMICAL Flowable, commercially available from Dow Chemical Company. Biocides may also act as preservatives. UV absorbers may include encapsulated hydroxyphenyl-triazine compositions and other compounds known to those of ordinary skill in the art, for example, TINUVIN 477DW, commercially available from BASF Corporation. Transfer agents such as polyvinyl alcohol (PVA) and other compounds known to those of ordinary skill in the art may also be included in the coating composition.

As described above, in certain embodiments, the gypsum panels described herein are “lightweight” panels, having a core density of no more than about 40 pcf. For example, in some embodiments, the panel has a panel weight of from about 800 to about 2500 lb/msf, such as from about 800 to about 2000 lb/msf, such as from about 800 to about 1600 lb/msf, such as from about 800 to about 1300 lb/msf, for a gypsum panel having a thickness of about ¼ inch to about 1 inch.

These panels may be relatively lightweight while also providing a high fire resistance level, but without the use of vermiculite. For example, the boards described herein may display similar or better thermal shrinkage and thermal transmission results than comparative boards containing vermiculite, such as measured according to ASTM C1795-15: Standard Test Methods for High-Temperature Characterization of Gypsum Boards and Panels. For example, the panels containing clay materials were discovered to display less deformation, under fire resistance testing, than a comparable board made with vermiculite.

Methods of constructing a building sheathing system are also provided herein, including installing at least two gypsum panels having an interface therebetween, and applying a seaming component at the interface between the at least two of the gypsum panels. Gypsum panels used in these methods may have any of the features, properties, or combinations of features and/or properties, described herein. Sheathing systems constructed by these methods may have any of the features, properties, or combinations or features and/or properties, described herein. The seaming component may be any suitable seaming component as described herein.

Panels and Systems

Gypsum panels having improved fire resistance and/or physical properties may be made by any of the methods described herein. In certain embodiments, gypsum panels include a set gypsum core containing clay in the absence of a non-clay fire resistant additive, wherein the panel displays a fire rating as described herein. In certain embodiments, gypsum panels include a set gypsum core containing a non-intumescent fire resistant additive, for example, in the absence of an intumescent fire resistant additive, wherein the panel displays a fire rating as described herein.

For example, a gypsum panel may include a gypsum core containing set gypsum and a fire resistant additive that is one or more clay materials, wherein the clay is present in the set gypsum core in an amount of from 0.5 to about 15 weight percent, and a mat facing material associated with a surface of the set gypsum core.

In some embodiments, a gypsum panel may include gypsum core containing set gypsum and a non-intumescent fire resistant additive. The non-intumescent fire resistant additive may include silica in an amount of at least 40% by weight of the non-intumescent fire resistant additive, and ceramic flux agent in a total amount of more than 0% by weight and less than or equal to 5% by weight of the non-intumescent fire resistant additive. The gypsum panel may include a mat facing material associated with a surface of the set gypsum core.

As discussed above, the panels may have a thickness from about ¼ inch to about 1 inch. For example, the panels may have a thickness of from about ½ inch to about ⅝ inch. The gypsum panels may be formed by the methods described herein.

Advantageously, these gypsum panels may display improved physical properties, such as resistance to expansion and deflection, as well as enhanced fire resistance. For example, the panels may display one or more of the following properties: a fire rating of equal to or greater than 60 minutes when measured according ASTM E119 or equivalent testing standards, an average volume shrinkage of 5% or less at temperatures up to 927° C., and an average thickness thermal shrinkage of 20% or less at temperatures up to 927° C. Additionally, the panels may have a relatively low density, as low as 30 lb/ft³ (pcf), such as less than 40 pcf, or less than 35 pcf, for example from 30 pcf to 45 pcf, or from 30 pcf to 40 pcf, while maintaining these fire performance and structural properties.

The clay material may be any suitable clay material, or combination of clay materials, described herein. In one embodiment, the clay is uncalcined kaolin, calcined kaolin, fire clay, ball clay, or a combination thereof. In certain embodiments, the clay is kaolin.

The one or more clay materials may be present in the set gypsum core in a relatively low amount, such as from about 0.5 to about 15 weight percent, from about 1 to about 10 weight percent, or from about 1.5 to about 6 weight percent, of the set gypsum core. In certain embodiments, the clay material is present in the set gypsum core in an amount of from about 30 to about 110 lb/msf, or lower, for a gypsum panel having a thickness of about ¼ inch to about 1 inch.

In certain embodiments, the non-intumescent fire resistant additive is present in the set gypsum core in an amount of from about 5 to about 110 lb/msf. In certain embodiments, a gypsum panel including non-intumescent fire resistant additive displays an average thickness thermal shrinkage of 20% or less, or 15% or less, 12% or less, or 10% or less, at temperatures up to 927° C.

In embodiments in which the gypsum panel includes a non-intumescent fire resistant additive, the panel may include low amounts of intumescent material, or no intumescent material. For example, the panel may include an intumescent fire resistant additive in an amount of no more than 1%, or no more than 0.5%, or no more than 0.1%, by weight of the gypsum panel. In certain embodiments, the gypsum panel is substantially free of any intumescent fire resistant additive. In certain embodiments, the intumescent fire resistant additive is vermiculite. Thus, the panel may have low amounts of, or substantially be free of, vermiculite. In certain embodiments, the panel is substantially free of asbestos.

The ceramic flux agent in the non-intumescent fire resistant agent may include a compound of an element selected from the group consisting of lead, sodium, potassium, lithium, calcium, magnesium, barium, zinc, strontium, or manganese. The compound may be an oxide, or another ceramic compound. In certain embodiments, the ceramic flux agent includes a compound of an element selected from the group consisting of lead, sodium, potassium, lithium, and boron, and the total amount of the ceramic flux agent is less than or equal to 5% by weight based on the total weight of the fire resistant additive. In certain embodiments, the ceramic flux agent includes a compound of an element selected from the group consisting of calcium, strontium, zinc, barium, and magnesium, and the total amount of the ceramic flux agent is less than or equal to 10% by weight based on the total weight of the fire resistant additive.

In certain embodiments, the non-intumescent fire resistant additive comprises S-glass fiber, E-glass fiber, or ball clay.

The silica in the non-intumescent fire resistant additive may include colloidal silica. In certain embodiments, the silica is present in an amount of 99% by weight or less of the fire resistant additive. In certain embodiments, the silica includes glass fibers. In certain embodiments, the glass fibers include S-type glass fibers.

In certain embodiments, as shown in FIG. 3, a gypsum panel 300 includes one or two paper facer materials 306, 314 that are associated with the gypsum core 301. The second facer 314 is present on a face of the gypsum core 301 opposite the first facer 306. In some embodiments, one or both of the facer materials 306, 314 may have a coating disposed on one or both surfaces thereof, prior to combination with the gypsum slurry, or, for external surface coatings, after combination with the gypsum slurry. In some embodiments, the gypsum core 301 includes three gypsum layers 302, 308, 310. One or both of the gypsum layers 302, 310 that are in contact with the facers 306, 314 may be a slate coat layer, as discussed herein.

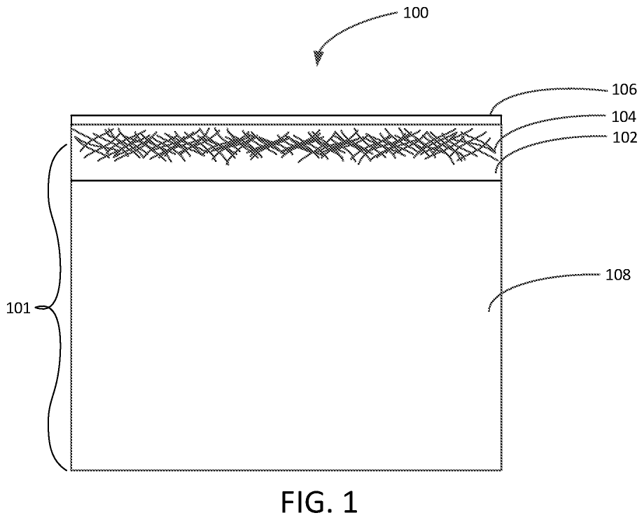

In some embodiments, as shown in FIG. 1, the gypsum of the gypsum core 101 penetrates a remaining portion of the first fibrous mat 104 such that voids in the mat 104 are substantially eliminated. For example, in one embodiment, the first mat 104 has a mat coating 106 on a surface opposite the gypsum core 101, the mat coating 106 penetrating a portion of the first mat 104, to define the remaining portion of the first mat 104. That is, gypsum of the gypsum core 101 may penetrate a remaining fibrous portion of the first fibrous mat 104 such that voids in the first mat 104 are substantially eliminated. As used herein the phrase “such that voids in the mat are substantially eliminated” and similar phrases, refer to the gypsum slurry, and thus the set gypsum, of the gypsum core filling all or nearly all of the interstitial volume of the fibrous mat that is not filled by the coating material. In certain embodiments, the gypsum of the gypsum core fills at least 95 percent of the available interstitial volume of the mat. In some embodiments, the gypsum core fills at least 98 percent of the available interstitial volume of the mat. In further embodiments, the gypsum core fills at least 99 percent of the available interstitial volume of the mat.

By maximizing gypsum slurry penetration into the side of the mat receiving gypsum, the movement of water under the mat coating within the glass mat of the finished panel when exposed to bulk water head pressures may be substantially and adequately reduced, without significantly altering the water vapor transmission rate (i.e., the ability to dry) of the finished panel. Thus, the gypsum panels disclosed herein may further display one or more improved water-resistive barrier properties.

In certain embodiments, the mat 104 is a nonwoven fiberglass mat. For example, the glass fibers may have an average diameter of from about 10 to about 17 microns and an average length of from about ¼ inch to about 1 inch. For example, the glass fibers may have an average diameter of 13 microns (i.e., K fibers) and an average length of ¾ inch. In certain embodiments, the nonwoven fiberglass mats have a basis weight of from about 1.5 pounds to about 3.5 pounds per 100 square feet of the mat. The mats may each have a thickness of from about 20 mils to about 35 mils. The fibers may be bonded together to form a unitary mat structure by a suitable adhesive. For example, the adhesive may be a urea-formaldehyde resin adhesive, optionally modified with a thermoplastic extender or cross-linker, such as an acrylic cross-linker, or an acrylate adhesive resin. In other embodiments, the mat facer may be a suitable paper facer material.

In certain embodiments, as shown in FIG. 1, the gypsum core 101 includes two or more gypsum layers 102, 108. For example, the gypsum core may include various gypsum layers having different compositions. In some embodiments, the first gypsum layer 102 that is in contact with the mat 104 (i.e., the layer that forms an interface with the coating material 106 and at least partially penetrates the first mat) is a slate coat layer. In some embodiments, the first gypsum layer 102 is present in an amount from about 5 percent to about 20 percent, by weight, of the gypsum core 101. In certain embodiments, the slate coat layer is formed from the first gypsum slurry described herein. In other embodiments, the entire panel core is formed from the first gypsum slurry. The first gypsum slurry may form one or more of these layers.

In certain embodiments, as shown in FIG. 2, a gypsum panel 200 includes two fibrous mats 204, 212 (which could alternatively be paper facers) that are associated with the gypsum core 201. The second mat 212 is present on a face of the gypsum core 201 opposite the first mat 204. In some embodiments, only the first mat 204 has a mat coating 206 on a surface thereof. In other embodiments, both mats 204, 212 have a coating 206, 214 on a surface thereof opposite the gypsum core 201. In some embodiments, the gypsum core 201 includes three gypsum layers 202, 208, 210. One or both of the gypsum layers 202, 210 that are in contact with the mats 204, 212 may be a slate coat layer.

In certain embodiments, as discussed above, the building panels described herein may display one or more improved performance characteristics such as fire resistance. Building sheathing systems are also provided herein, and include at least two of the improved water-resistive gypsum panels described herein, including any features, or combinations of features, of the panels described herein.

In certain embodiments, a building sheathing system, or assembly, includes at least two gypsum panels and a seaming component configured to provide a seam at an interface between at least two of the gypsum panels. In certain embodiments, the seaming component comprises tape or a bonding material. For example, the seaming component may be a tape including solvent acrylic adhesives, a tape having a polyethylene top layer with butyl rubber adhesive, a tape having an aluminum foil top layer with butyl rubber adhesive, a tape having an EPDM top layer with butyl rubber adhesive, a tape having a polyethylene top layer with rubberized asphalt adhesive, or a tape having an aluminum foil top layer with rubberized asphalt adhesive or rubberized asphalt adhesives modified with styrene butadiene styrene. For example, the seaming component may be a bonding material containing silyl terminated polyether, silyl modified polymers, silicones, synthetic stucco plasters and/or cement plasters, synthetic acrylics, sand filled acrylics, and/or joint sealing chemistries comprising solvent based acrylics, solvent based butyls, latex (water-based, including EVA, acrylic), polysulfides, polyurethanes, and latexes (water-based, including EVA, acrylic).

Thus, the above-described enhanced panels may be installed with either a tape, liquid polymer, or other suitable material, to effectively treat areas of potential water and air intrusion, such as seams, door/window openings, penetrations, roof/wall interfaces, and wall/foundation interfaces.

In certain embodiments, a building assembly including a plurality of the gypsum panels described herein passes one or more of the following standards: 2005 National Building Code of Canada and 2006 British Columbia Section 9.27.2.2, Item 1b; ASTM E 2273-03 Standard Test Method for determining the Draining Efficiency of Exterior Insulating and Finish Systems (EIFS) Clad Wall Assemblies; ASTM E 2925-17, Standard Specification for Manufactured Polymeric Drainage and Ventilation Materials; and ASTM C1715-10, Standard Test Method for Evaluation of Water Leakage Performance of Masonry Wall Drainage Systems.

### EXAMPLES

Embodiments of the gypsum panels disclosed herein were constructed and tested, as described below.

### Example 1

⅝ inch gypsum panel samples were prepared containing various amounts and types of clays. In particular, Old Hickory (OH) ball clay #5 (commercially available from Old Hickory Clay Company), Old Hickory uncalcined (“uc”) kaolin (commercially available from Old Hickory Clay Company), KaMin® 70C calcined (“c”) kaolin (commercially available from KaMin LLC/CADAM, formerly Huber), MetaMax® kaolin (commercially available from BASF), KaMin® HG90 kaolin (commercially available from KaMin LLC/CADAM, formerly Huber), Metapor® metakaolin (commercially available from Poraver), and Lincoln 60 fireclay (commercially available from Gladding McBean Lincoln Clay).

The samples were tested according to High Temperature Shrinkage and High Temperature Thermal Transmission, as outlined in ASTM C1795-15: Standard Test Methods for High-Temperature Characterization of Gypsum Boards and Panels, as well as and High Temperature Volume Expansion Test and dilatometer, which are used to characterize the fire resistant properties of a sample. The High Temperature Volume Expansion Tests were performed on the individual raw materials and a dilatometer was used to evaluate volumetric change in the gypsum panel using a dilatometer.

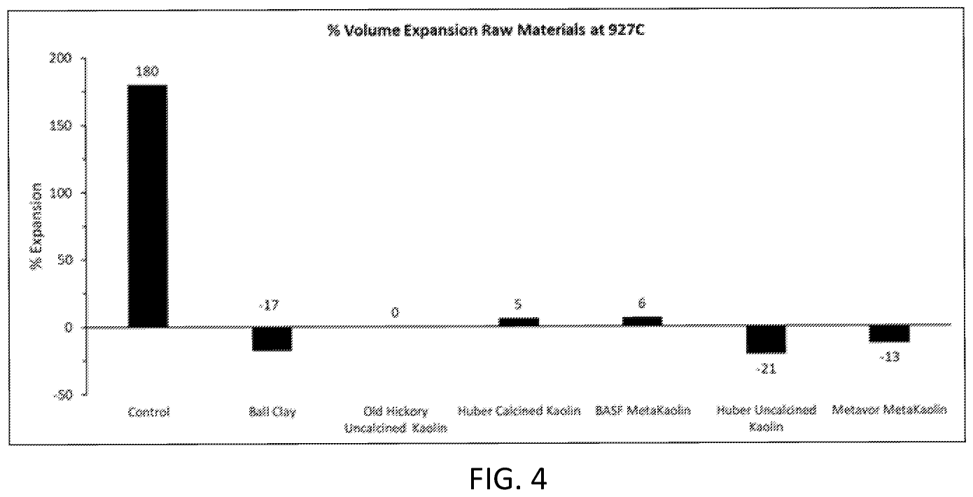

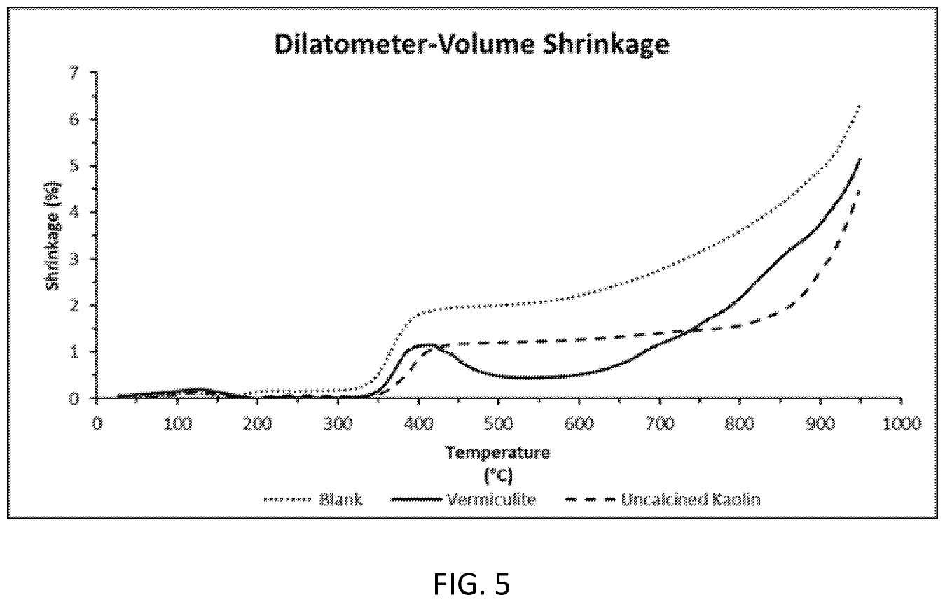

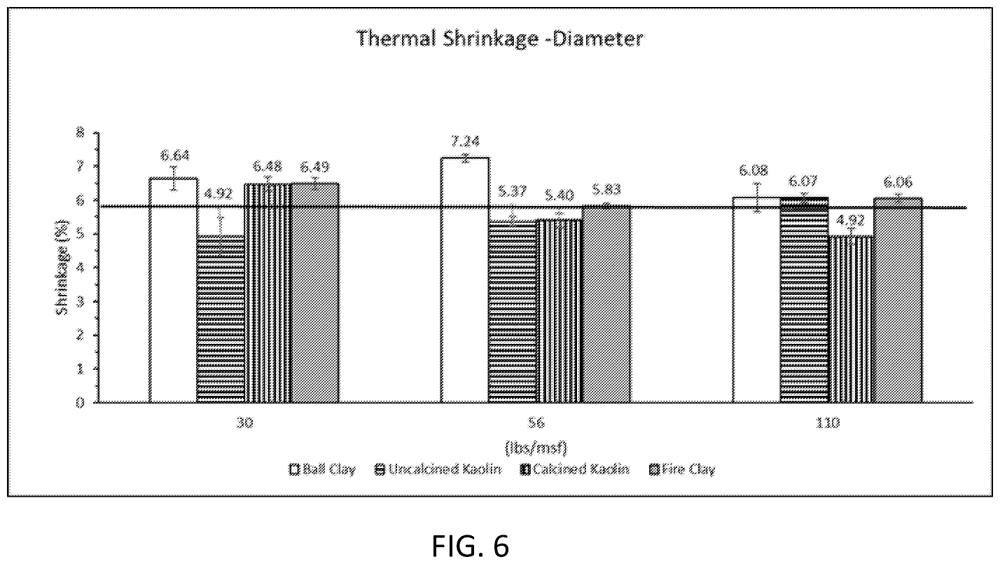

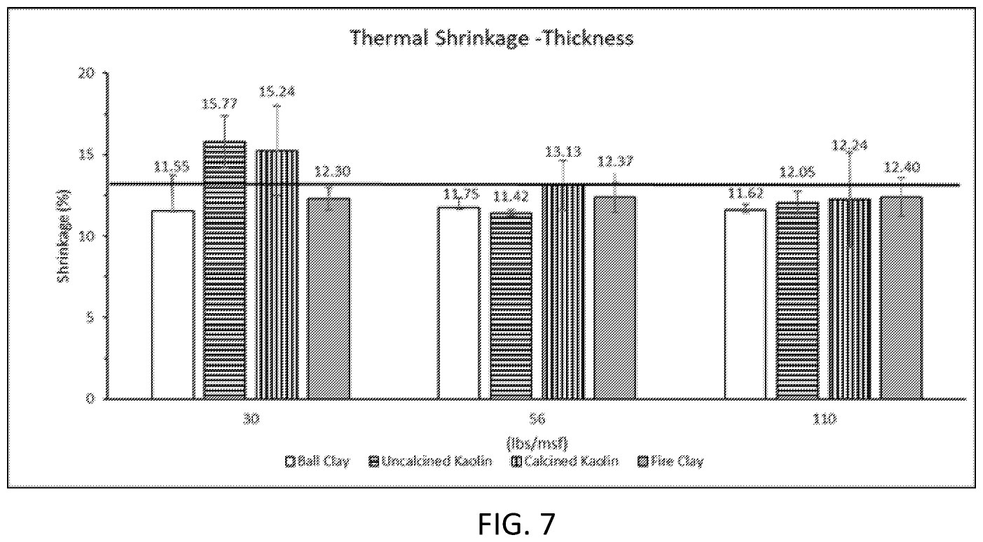

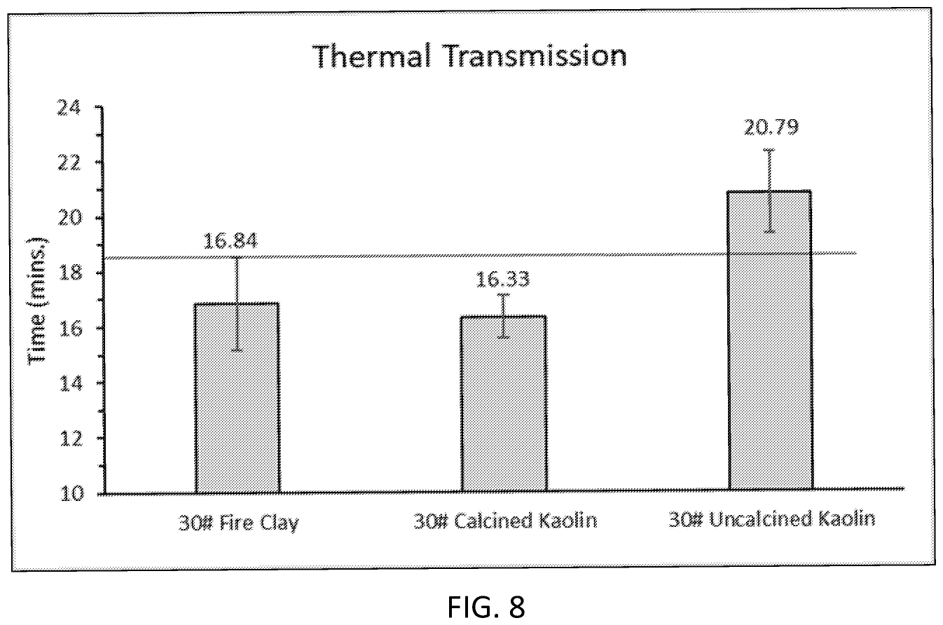

The results are shown in FIGS. 4-8. As can be seen in FIG. 4, the raw material vermiculite displayed significant volume expansion (average 180%), while the clay raw materials displayed average volume expansion in the range of −21% to 6%, i.e., substantially no expansion upon exposure to high temperatures. As can be seen in FIG. 5, the panels containing vermiculite displayed a decrease in volume shrinkage from 400-500° C., while clay-containing panel displayed a gradual increase in volume shrinkage from 400-500° C. As can be seen in FIGS. 6 and 7, clay-containing panels at various load amounts also display an ability to prevent shrinkage (both diameter and thickness). FIGS. 6 and 7 include the shrinkage for a comparative vermiculite panel (black line). As can be seen, the clay-containing panels perform similarly to the vermiculite panels in preventing diameter and thickness shrinkage. FIG. 8 shows the thermal transmission properties of certain clay containing panels, as well as a comparative vermiculite panel (black line). As can be seen, the clays have comparable or better transmission of heat than vermiculite containing panels.

Thus, gypsum panels were achieved that display one or more of the following properties: an average volume shrinkage of 5% or less at temperatures up to 927° C., and an average thickness thermal shrinkage of 20% or less at temperatures up to 927° C. These panels may outperform otherwise identical panels containing vermiculite or other fire resistant additives.

Next, a plant trial was run incorporating 30 pounds of uncalcined kaolin in ⅝″ gypsum wallboard at a target board weight of 1897 lbs/msf, which is roughly 30 pcf. An ASTM E119 floor/ceiling assembly test was conducted on a test wall constructed as described in ASTM C1396 on each side of the partition. The test confirmed that the panels display a fire rating of not less than one hour when tested in accordance with ASTM Test Method E119: Standard Test Methods for Fire Tests of Building Construction and Materials, including for Type X and Type C panels, which represents an enhanced fire rating over commercially available panels.

### Example 2

⅝ inch gypsum panel samples were prepared with non-intumescent fire resistant additive, having at least 40% by weight of silica, and 2% or less by weight of a ceramic flux agent. The flux agent included compounds that affected the melting temperature of silica, such as potassium oxide and sodium oxide.

⅝ inch gypsum panel samples were prepared containing various amounts and types of non-intumescent fire resistant agents. Different samples were prepared for each of the following non-intumescent fire resistant agents having low amount of flux agent (2% or less by weight): ball clay, e-glass fiber, and s-glass fiber. Samples were also prepared with colloidal silica and diatomaceous earth, without any flux agent. Further sample were prepared for each of the following non-intumescent fire resistant agents having a high amount of total flux agent (more than 2% by weight): sodium silicate, soda lime glass microspheres, and pumice.

TABLE 1
Additive composition (% by weight)

| | | | Magnesium | Calcium | Iron | Potassium | Sodium |
|---|---|---|---|---|---|---|---|
| Additives | Silica | Alumina | Oxide | Oxide | Oxide | Oxide | Oxide |
| Ball Clay | 59 | 25 | .3 | .3 | 0 | .9 | .4 |
| E Glass Fiber | 52-56 | 12-16 | 0-5 | 16-25 | .05-.4 | 0-2 | |
| S Glass Fiber | 64-66 | 24-26 | 9-11 | 0-.3 | 0-.3 | 0-.3 | |
| Colloidal Silica | 90 | | | | | | |
| Diatomaceous Earth | 80-90 | 2-4 | | | 0.05-2 | | |
| Sodium Silicate | 25-33 | 0 | 0 | 0 | 0 | 0 | 8-17 |
| Soda Lime | 70-75 | 0.5-5 | 0-5 | 7-11 | 0 | 0-4 | 10-15 |
| Glass Microspheres | | | | | | | |
| Pumice | 76.2 | 13.5 | 0.05 | .8 | .1 | 1.8 | 1.6 |

TABLE 2
Additive composition (% by weight)

| | | Boron | | |
|---|---|---|---|---|
| Additives | Titania | Oxide | Fluorine | Water |
| Ball Clay | 1 | | 0 | |
| E Glass Fiber | 0-.8 | 5-10 | 0-1.0 | 0 |
| S Glass Fiber | | | | |
| Colloidal Silica | | | | |
| Diatomaceous Earth | | | | |
| Soda Lime Glass Microspheres | | | | |
| Pumice | .2 | 0 | 0 | <1.0 |

The compositions of the additives are shown in TABLES 1 and 2.

The samples were tested according to High Temperature Shrinkage, as outlined in ASTM C1795-15: Standard Test Methods for High-Temperature Characterization of Gypsum Boards and Panels, as well as and High Temperature Volume Expansion Test and dilatometer, which are used to characterize the fire resistant properties of a sample. The High Temperature Volume Expansion Tests were performed on the individual raw materials and a dilatometer was used to evaluate volumetric change in the gypsum panel using a dilatometer.

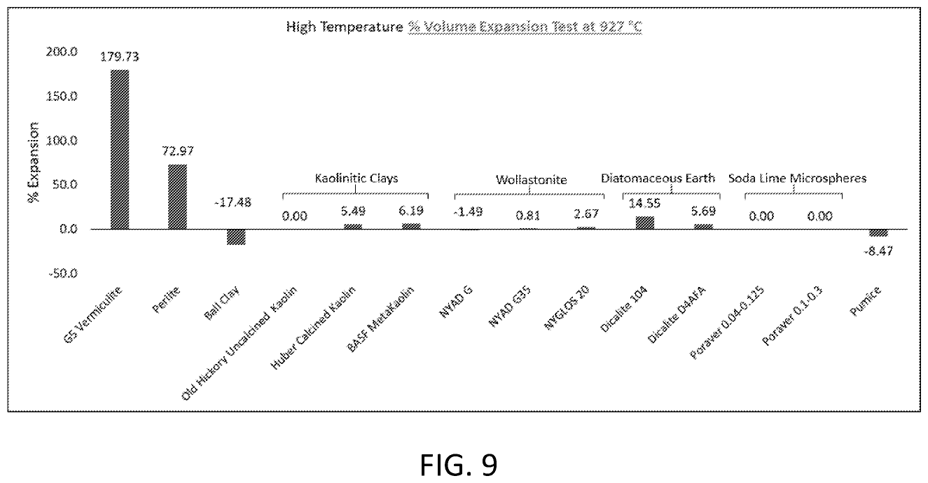

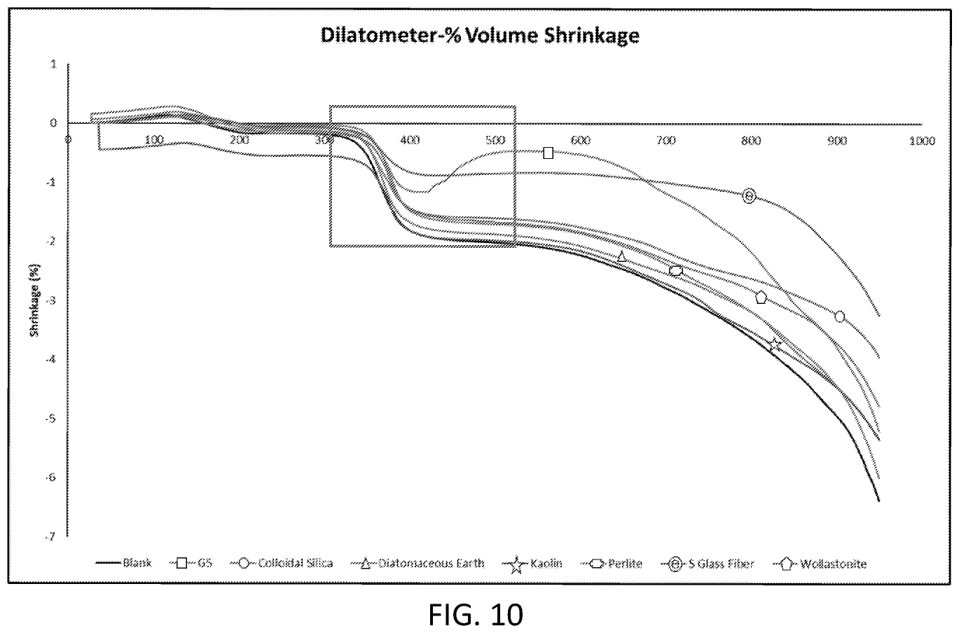

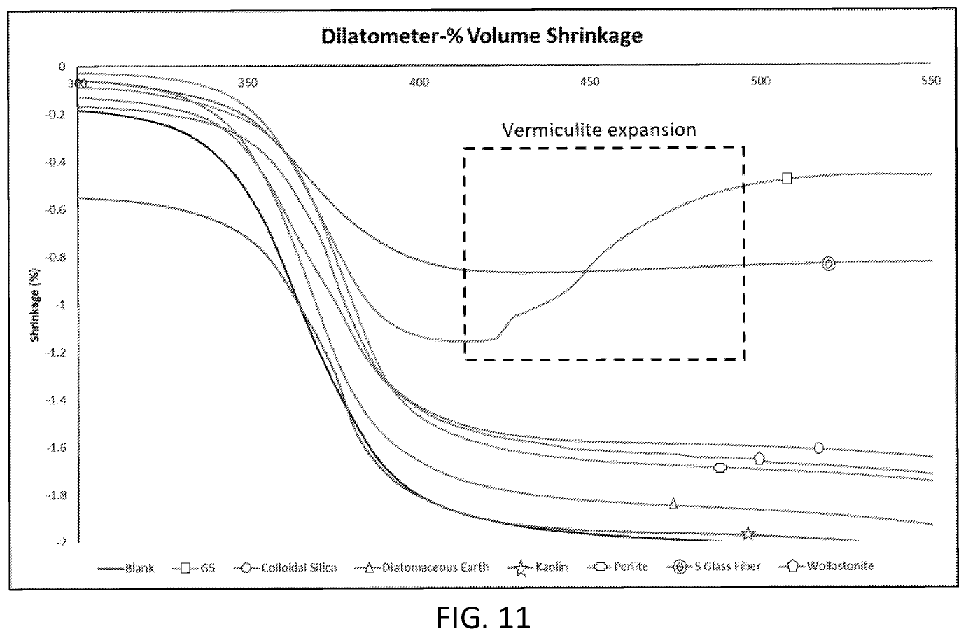

The results are shown in FIGS. 9-11 and TABLE 3. As can be seen in FIG. 9, the raw material vermiculite displayed significant volume expansion (average 180%), while the non-intumescent materials displayed average volume expansion in the range of −17.48% to 15%, i.e., substantially no expansion upon exposure to high temperatures. As can be seen in FIGS. 10 and 11, the panels containing vermiculite displayed a decrease in volume shrinkage from 400-500° C., while panels containing non-intumescent material displayed a gradual increase in volume shrinkage from 400-500° C.

TABLE 3
Diameter and Thickness Shrinkage

| | Material | Diameter | Thickness |
|---|---|---|---|
| | Loading | Shrinkage | Shrinkage |
| Raw Material | (#/msf) | (%) | (%) |
| Vermiculite | 70 | 5.82 ± 0.29 | 13.39 ± 0.85 |
| S-Glass Fiber | 6 | 4.13 ± 0.13 | 9.71 ± 1.04 |
| E-Glass Fiber | 6 | 7.31 ± 0.44 | 13.21 ± 1.88 |
| Fire Clay | 110 | 6.06 ± 0.13 | 12.40 ± 1.19 |
| | 56 | 5.83 ± 0.07 | 12.37 ± 0.92 |
| | 30 | 6.49 ± 0.17 | 12.30 ± 0.68 |
| Calcined Kaolin | 110 | 5.40 ± 0.26 | 13.41 ± 1.52 |
| | 56 | 5.98 ± 0.26 | 13.63 ± 1.52 |
| | 30 | 5.99 ± 0.21 | 13.68 ± 0.84 |
| Uncalcined Kaolin | 110 | 6.07 ± 0.13 | 12.05 ± 0.69 |
| | 56 | 5.37 ± 0.13 | 11.42 ± 0.17 |
| | 30 | 4.92 ± 0.56 | 15.77 ± 1.60 |
| Ball Clay | 110 | 6.08 ± 0.42 | 11.62 ± 0.33 |
| | 56 | 7.24 ± 0.10 | 11.75 ± 0.58 |
| | 30 | 6.64 ± 0.34 | 11.55 ± 2.20 |
| Colloidal Silica | 10 | 5.03 ± 0.34 | 14.62 ± 1.79 |
| | 5 | 5.38 ± 0.41 | 13.08 ± 2.77 |
| Wollastonite | 70 | 5.36 ± 0.15 | 12.00 ± 0.85 |
| | 30 | 5.05 ± 0.75 | 13.05 ± 3.97 |
| Diatomaceous | 70 | 4.65 ± 0.17 | 10.34 ± 1.26 |
| Earth | 30 | 5.38 ± 0.45 | 13.03 ± 3.16 |
| Sodium Silicate | 70 | 9.48 ± 0.11 | 21.29 ± 1.65 |
| Soda Lime Glass | 70 | 19.65 ± 0.38 | 28.09 ± 0.87 |
| Microspheres | 30 | 12.09 ± 0.39 | 19.87 ± 2.93 |
| | 10 | 9.40 ± 0.56 | 15.74 ± 7.07 |

As can be seen in TABLE 3, panels including non-intumescent materials at various load amounts also displayed an ability to prevent shrinkage (both diameter and thickness), including non-intumescent materials including trace or low amounts of ceramic flux agents. The non-intumescent panels perform similarly to the vermiculite panels in preventing diameter and thickness shrinkage.

Thus, gypsum panels were achieved that display one or more of the following properties: an average volume shrinkage of 5% or less at temperatures up to 927° C., and an average thickness thermal shrinkage of 20% or less at temperatures up to 927° C., and in particular, 15% or less for ball clay, s-glass fiber, and e-glass fiber. These panels may outperform otherwise identical panels containing vermiculite or other fire resistant additives.

Additives with high silica (40% or more by weight) and low amounts of total flux agent (2% or less) performed well. For example, ball clay, e-glass fiber, and s-glass fiber resulted in good performance. Additives with high silica (40% or more by weight) and high amounts of total flux agent (more than 2%), for example, sodium silicate, soda lime glass microspheres, and pumice, did not provide good performance.

Thus, it has been discovered that gypsum panels, sheathing, roofing, or other construction boards or panels may be formed using clay materials or non-intumescent materials as the sole fire resistant additive to achieve fire resistance and/or physical properties comparable to or better than similar boards containing vermiculite or other fire resistant materials. These panels may be relatively lightweight while also providing a high fire resistance level, but without the use of vermiculite, as compared to commercially available panels. For example, the boards described herein may display similar or better thermal shrinkage and thermal transmission results than comparative boards containing vermiculite, such as measured according to ASTM C1795-15: Standard Test Methods for High-Temperature Characterization of Gypsum Boards and Panels. For example, the panels containing clays were discovered to display less structural deflection than a comparable board made with vermiculite under fire resistance testing.

### Aspects

Aspect 1. A gypsum panel, including:
a set gypsum core including a fire resistant additive, the fire resistant additive consisting essentially of clay, wherein the clay is present in the set gypsum core in an amount of from about 0.5 to about 15 weight percent; and
a mat facing material associated with a surface of the set gypsum core,
wherein the gypsum panel displays a fire rating of not less than one hour when constructed as according to ASTM C1396 and tested in accordance with ASTM Test Method E119: Standard Test Methods for Fire Tests of Building Construction and Materials.
   Aspect 2. The gypsum panel of aspect 1, wherein the gypsum panel displays a fire rating of not less than one hour when constructed as according to ASTM C1396 and tested in accordance with ASTM Test Method E119: Standard Test Methods for Fire Tests of Building Construction and Materials, for Type X and Type C panels.
   Aspect 3. The gypsum panel of aspect 1 or 2, wherein the clay is present in the set gypsum core in an amount of from about 1 to about 10 weight percent.
   Aspect 4. The gypsum panel of aspect 3, wherein the clay is present in the set gypsum core in an amount of from about 1.5 to about 6 weight percent.
   Aspect 5. The gypsum panel of any of aspects 1 to 4, wherein the clay is uncalcined kaolin, calcined kaolin, fire clay, ball clay, or any combination thereof.
   Aspect 6. The gypsum panel of any of aspects 1 to 4, wherein the clay is kaolin.
   Aspect 7. The gypsum panel of any of aspects 1 to 6, wherein the clay is present in the set gypsum core in an amount of from about 30 to about 110 lb/msf.
   Aspect 8. The gypsum panel of any of aspects 1 to 7, wherein the gypsum panel has a density of less than 40 pcf.
   Aspect 9. The gypsum panel of aspect 8, wherein the gypsum panel has a density of less than 35 pcf.
   Aspect 10. The gypsum panel of any of aspects 1 to 9, wherein the gypsum panel displays an average volume shrinkage of 5% or less at temperatures up to 927° C.
   Aspect 11. The gypsum panel of any one of aspects 1 to 9, wherein the gypsum panel displays an average thickness thermal shrinkage of 20% or less at temperatures up to 927° C.
   Aspect 12. The gypsum panel of any of aspects 1 to 11, wherein the set gypsum core further includes a structural reinforcing material.
   Aspect 13. The gypsum panel of aspect 12, wherein the structural reinforcing material includes glass fibers.
   Aspect 14. A building assembly including a plurality of the gypsum panels of any of aspects 1 to 13, wherein the assembly passes one or more of the following standards:
2005 National Building Code of Canada and 2006 British Columbia Section 9.27.2.2, Item 1b;
ASTM E 2273-03 Standard Test Method for determining the Draining Efficiency of Exterior Insulating and Finish Systems (EIFS) Clad Wall Assemblies;
ASTM E 2925-17, Standard Specification for Manufactured Polymeric Drainage and Ventilation Materials; and
ASTM C1715-10, Standard Test Method for Evaluation of Water Leakage Performance of Masonry Wall Drainage Systems.
   Aspect 15. A method of making a gypsum panel, including:
forming a first gypsum slurry by combining stucco, water, and a fire resistant additive, the fire resistant additive consisting essentially of clay;
setting the first gypsum slurry to form at least part of a core of the gypsum panel; and
associating a mat facing material with a surface of the set gypsum core,
wherein the clay is present in the set gypsum core in an amount of from about 0.5 to about 15 weight percent,
wherein the gypsum panel displays a fire rating not less than one hour when constructed as according to ASTM C1396 and tested in accordance with ASTM Test Method E119: Standard Test Methods for Fire Tests of Building Construction and Materials.
   Aspect 16. The method of aspect 15, wherein the gypsum panel displays a fire rating of not less than one hour when constructed as according to ASTM C1396 and tested in accordance with ASTM Test Method E119: Standard Test Methods for Fire Tests of Building Construction and Materials, for Type X and Type C panels.
   Aspect 17. The method of aspect 15 or 16, wherein the clay is present in the set gypsum core in an amount of from about 1 to about 10 weight percent.
   Aspect 18. The method of aspect 17, wherein the clay is present in the set gypsum core in an amount of from about 1.5 to about 6 weight percent.
   Aspect 19. The method of any of aspects 15 to 18, wherein the clay is uncalcined kaolin, calcined kaolin, fire clay, ball clay, or any combination thereof.
   Aspect 20. The method of any one of aspects 15 to 18, wherein the clay is kaolin.
   Aspect 21. The method of any one of aspects 15 to 20, wherein the clay is present in the set gypsum core in an amount of from about 30 to about 110 lb/msf.
   Aspect 22. The method of any one of aspects 15 to 21, wherein the gypsum panel has a density of less than 40 pcf.
   Aspect 23. The method of aspect 22, wherein the gypsum panel has a density of less than 35 pcf.
   Aspect 24. The method of any of aspects 15 to 23, wherein the gypsum panel displays an average volume shrinkage of 5% or less at temperatures up to 927° C.
   Aspect 25. The method of any of aspects 15 to 23, wherein the gypsum panel displays an average thickness thermal shrinkage of 20% or less at temperatures up to 927° C.
   Aspect 26. The method of any of aspects 15 to 25, wherein the first gypsum slurry further includes a structural reinforcing material.
   Aspect 27. The method of aspect 26, wherein the structural reinforcing material includes glass fibers.
   Aspect 28. A gypsum panel, including:
a set gypsum core including clay in the absence of any non-clay fire resistant additives present in an amount effective to alter the fire resistance performance of the panel,
a mat facing material associated with a surface of the set gypsum core,
wherein the gypsum panel displays a fire rating not less than one hour when constructed as according to ASTM C1396 and tested in accordance with ASTM Test Method E119: Standard Test Methods for Fire Tests of Building Construction and Materials.
   Aspect 29. The gypsum panel of aspect 28, wherein the clay is present in the gypsum core in an amount of from about 0.5 to about 15 weight percent.
   Aspect 30. The gypsum panel of aspect 29, wherein the clay is present in the set gypsum core in an amount of from about 1 to about 10 weight percent.
   Aspect 31. The gypsum panel of aspect 30, wherein the clay is present in the set gypsum core in an amount of from about 1.5 to about 6 weight percent.
   Aspect 32. The gypsum panel of any of aspects 28 to 31, wherein the gypsum panel displays a fire rating of not less than one hour when constructed as according to ASTM C1396 and tested in accordance with ASTM Test Method E119: Standard Test Methods for Fire Tests of Building Construction and Materials, for Type X and Type C panels.
   Aspect 33. The gypsum panel of any of aspects 28 to 32, wherein the clay is uncalcined kaolin, calcined kaolin, fire clay, ball clay, or any combination thereof.
   Aspect 34. The gypsum panel of any of aspects 28 to 32, wherein the clay is kaolin.
   Aspect 35. The gypsum panel of any of aspects 28 to 34, wherein the clay is present in the set gypsum core in an amount of from about 30 to about 110 lb/msf.
   Aspect 36. The gypsum panel of any of aspects 28 to 35, wherein the gypsum panel has a density of less than 40 pcf.
   Aspect 37. The gypsum panel of aspect 36, wherein the gypsum panel has a density of less than 35 pcf.
   Aspect 38. The gypsum panel of any of aspects 28 to 37, wherein the gypsum panel displays an average volume shrinkage of 5% or less at temperatures up to 927° C.
   Aspect 39. The gypsum panel of any of aspects 28 to 37, wherein the gypsum panel displays an average thickness thermal shrinkage of 20% or less at temperatures up to 927° C.
   Aspect 40. The gypsum panel of any of aspects 28 to 39, wherein the set gypsum core further includes a structural reinforcing material.
   Aspect 41. The gypsum panel of aspect 40, wherein the structural reinforcing material includes glass fibers.
   Aspect 42. A building assembly including a plurality of the gypsum panels of any of aspects 28 to 41, wherein the assembly passes one or more of the following standards:
2005 National Building Code of Canada and 2006 British Columbia Section 9.27.2.2, Item 1b;
ASTM E 2273-03 Standard Test Method for determining the Draining Efficiency of Exterior Insulating and Finish Systems (EIFS) Clad Wall Assemblies;
ASTM E 2925-17, Standard Specification for Manufactured Polymeric Drainage and Ventilation Materials; and
ASTM C1715-10, Standard Test Method for Evaluation of Water Leakage Performance of Masonry Wall Drainage Systems.
   Aspect 43. A gypsum panel, including:
a set gypsum core including a non-intumescent fire resistant additive, the non-intumescent fire resistant additive comprising:
   silica in an amount of at least 40% by weight of the non-intumescent fire resistant additive, and
   ceramic flux agent in a total amount of more than 0% by weight and less than or equal to 5% by weight of the non-intumescent fire resistant additive; and a mat facing material associated with a surface of the set gypsum core.
      Aspect 44. The gypsum panel of aspect 43, wherein the gypsum panel displays a fire rating of not less than one hour when constructed as according to ASTM C1396 and tested in accordance with ASTM Test Method E119: Standard Test Methods for Fire Tests of Building Construction and Materials.
      Aspect 45. The gypsum panel of aspect 43, wherein the gypsum panel displays a fire rating of not less than one hour when constructed as according to ASTM C1396 and tested in accordance with ASTM Test Method E119: Standard Test Methods for Fire Tests of Building Construction and Materials, for Type X and Type C panels.
      Aspect 46. The gypsum panel of any of aspects 43 to 45, wherein the gypsum panel exhibits improved fire resistance compared to a gypsum panel of like composition without the non-intumescent fire resistant additive.
      Aspect 47. The gypsum panel of any of aspects 43 to 46, wherein the non-intumescent fire resistant additive is present in the set gypsum core in an amount of from about 5 to about 110 lb/msf.
      Aspect 48. The gypsum panel of any of aspects 43 to 47, wherein the non-intumescent fire resistant additive comprises S-glass fiber, E-glass fiber, or ball clay.
      Aspect 49. The gypsum panel of any of aspects 43 to 48, wherein the gypsum panel has a density of less than 40 pcf.
      Aspect 50. The gypsum panel of aspect 49, wherein the gypsum panel has a density of less than 35 pcf.
      Aspect 51. The gypsum panel of any one of aspects 43 to 50, wherein the gypsum panel displays an average thickness thermal shrinkage of 20% or less at temperatures up to 927° C.
      Aspect 52. The gypsum panel of aspect 51, wherein the gypsum panel displays an average thickness thermal shrinkage of 15% or less at temperatures up to 927° C.
      Aspect 53. The gypsum panel of aspect 52, wherein the gypsum panel displays an average thickness thermal shrinkage of 12% or less at temperatures up to 927° C.
      Aspect 54. The gypsum panel of aspect 52, wherein the gypsum panel displays an average thickness thermal shrinkage of 10% or less at temperatures up to 927° C.
      Aspect 55. The gypsum panel of any of aspects 43 to 54, wherein the gypsum panel comprises an intumescent fire resistant additive in an amount of no more than 1% by weight of the gypsum panel.
      Aspect 56. The gypsum panel of aspect 55, wherein the intumescent fire resistant additive is present in an amount of no more than 0.5% by weight of the gypsum panel.
      Aspect 57. The gypsum panel of aspect 56, wherein the intumescent fire resistant additive is present in an amount of no more than 0.1% by weight of the gypsum panel.
      Aspect 58. The gypsum panel of any of aspects 43 to 57, wherein the gypsum panel is substantially free of any intumescent fire resistant additive.
      Aspect 59. The gypsum panel of any of aspects 55 to 58, wherein the intumescent fire resistant additive is vermiculite.
      Aspect 60. The gypsum panel of any of aspects 43 to 59, wherein the gypsum panel is substantially free of asbestos.
      Aspect 61. The gypsum panel of any of aspects 43 to 60, wherein the ceramic flux agent comprises a compound of an element selected from the group consisting of lead, sodium, potassium, lithium, calcium, magnesium, barium, zinc, strontium, or manganese.
      Aspect 62. The gypsum panel of any of aspects 43 to 61, wherein the silica comprises colloidal silica.
      Aspect 63. The gypsum panel of any of aspects 43 to 62, wherein the silica is present in an amount of 99% by weight or less of the fire resistant additive.
      Aspect 64. The gypsum panel of any one of aspects 43 to 63, wherein the silica comprises glass fibers.
      Aspect 65. The gypsum panel of aspect 64, wherein the glass fibers comprise S-type glass fibers.
      Aspect 66. The gypsum pane of any of aspects 43 to 65, wherein the ceramic flux agent comprises a compound of an element selected from the group consisting of lead, sodium, potassium, lithium, and boron, and the total amount of the ceramic flux agent is less than or equal to 5% by weight based on the total weight of the fire resistant additive.
      Aspect 67. The gypsum pane of any of aspects 43 to 66, wherein the ceramic flux agent comprises a compound of an element selected from the group consisting of calcium, strontium, zinc, barium, and magnesium, and the total amount of the ceramic flux agent is less than or equal to 10% by weight based on the total weight of the fire resistant additive.
      Aspect 68. The gypsum panel of any of aspects 43 to 67, wherein the set gypsum core further includes a structural reinforcing material.
      Aspect 69. The gypsum panel of aspect 68, wherein the structural reinforcing material includes glass fibers.
      Aspect 70. A building assembly including a plurality of the gypsum panels of any of aspects 43 to 69, wherein the assembly passes one or more of the following standards:
2005 National Building Code of Canada and 2006 British Columbia Section 9.27.2.2, Item 1b;
ASTM E 2273-03 Standard Test Method for determining the Draining Efficiency of Exterior Insulating and Finish Systems (EIFS) Clad Wall Assemblies;
ASTM E 2925-17, Standard Specification for Manufactured Polymeric Drainage and Ventilation Materials; and
ASTM C1715-10, Standard Test Method for Evaluation of Water Leakage Performance of Masonry Wall Drainage Systems.
   Aspect 71. A method of making a gypsum panel, including:
forming a first gypsum slurry by combining stucco, water, and a non-intumescent fire resistant additive, the non-intumescent fire resistant additive comprising:
   silica in an amount of at least 40% by weight of the non-intumescent fire resistant additive, and
   ceramic flux agent in a total amount of more than 0% by weight and less than or equal to 5% by weight of the non-intumescent fire resistant additive; setting the first gypsum slurry to form at least part of a core of the gypsum panel; and associating a mat facing material with a surface of the set gypsum core.
      Aspect 72. The method of aspect 71, wherein the gypsum panel displays a fire rating not less than one hour when constructed as according to ASTM C1396 and tested in accordance with ASTM Test Method E119: Standard Test Methods for Fire Tests of Building Construction and Materials.
      Aspect 73. The method of aspect 71, wherein the gypsum panel displays a fire rating of not less than one hour when constructed as according to ASTM C1396 and tested in accordance with ASTM Test Method E119: Standard Test Methods for Fire Tests of Building Construction and Materials, for Type X and Type C panels.
      Aspect 74. The method of any of aspects 71 to 73, wherein the gypsum exhibits improved fire resistance compared to a gypsum panel of like composition without the non-intumescent fire resistant additive.
      Aspect 75. The method of any of aspects 71 to 74, wherein the non-intumescent fire resistant additive is present in the set gypsum core in an amount of from about 5 to about 110 lb/msf.
      Aspect 76. The method of any of aspects 71 to 75, wherein the non-intumescent fire resistant additive comprises S-glass fiber, E-glass fiber, or ball clay.
      Aspect 77. The method of any of aspects 71 to 76, wherein the gypsum panel has a density of less than 40 pcf.
      Aspect 78. The method of aspect 77, wherein the gypsum panel has a density of less than 35 pcf.
      Aspect 79. The method of any one of aspects 71 to 78, wherein the gypsum panel displays an average thickness thermal shrinkage of 20% or less at temperatures up to 927° C.
      Aspect 80. The method of aspect 79, wherein the gypsum panel displays an average thickness thermal shrinkage of 15% or less at temperatures up to 927° C.
      Aspect 81. The method of aspect 80, wherein the gypsum panel displays an average thickness thermal shrinkage of 12% or less at temperatures up to 927° C.
      Aspect 82. The method of aspect 80, wherein the gypsum panel displays an average thickness thermal shrinkage of 10% or less at temperatures up to 927° C.
      Aspect 83. The method of any of aspects 71 to 82, wherein the gypsum panel comprises an intumescent fire resistant additive in an amount of no more than 1% by weight of the gypsum panel.
      Aspect 84. The method of aspect 83, wherein the intumescent fire resistant additive is present in an amount of no more than 0.5% by weight of the gypsum panel.
      Aspect 85. The method of aspect 84, wherein the intumescent fire resistant additive is present in an amount of no more than 0.1% by weight of the gypsum panel.
      Aspect 86. The method of any of aspects 71 to 85, wherein the gypsum panel is substantially free of any intumescent fire resistant additive.
      Aspect 87. The method of any of aspects 83 to 86, wherein the intumescent fire resistant additive is vermiculite.
      Aspect 88. The method of any of aspects 71 to 87, wherein the gypsum panel is substantially free of asbestos.
      Aspect 89. The method of any of aspects 71 to 88, wherein the ceramic flux agent comprises a compound of an element selected from the group consisting of lead, sodium, potassium, lithium, calcium, magnesium, barium, zinc, strontium, or manganese.
      Aspect 90. The method of any of aspects 71 to 89, wherein the silica comprises colloidal silica.
      Aspect 91. The method of any of aspects 71 to 90, wherein the silica is present in an amount of 99% by weight or less of the fire resistant additive.
      Aspect 92. The method of any one of aspects 71 to 90, wherein the silica comprises glass fibers.
      Aspect 93. The method of aspect 92, wherein the glass fibers comprise S-type glass fibers.
      Aspect 94. The gypsum pane of any of aspects 71 to 93, wherein the ceramic flux agent comprises a compound of an element selected from the group consisting of lead, sodium, potassium, lithium, and boron, and the total amount of the ceramic flux agent is less than or equal to 5% by weight based on the total weight of the fire resistant additive.
      Aspect 95. The gypsum pane of any of aspects 71 to 94, wherein the ceramic flux agent comprises a compound of an element selected from the group consisting of calcium, strontium, zinc, barium, and magnesium, and the total amount of the ceramic flux agent is less than or equal to 10% by weight based on the total weight of the fire resistant additive.
      Aspect 96. The method of any of aspects 71 to 95, wherein the set gypsum core further includes a structural reinforcing material.
      Aspect 97. The method of aspect 96, wherein the structural reinforcing material includes glass fibers.

While the disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A gypsum panel, comprising:
a set gypsum core comprising a fire resistant additive, the fire resistant additive consisting essentially of clay, wherein the clay is present in the set gypsum core in an amount of from about 0.5 to about 15 weight percent; and
a mat facing material associated with a surface of the set gypsum core,
wherein the panel displays a fire rating of not less than one hour when constructed as according to ASTM C1396 and tested in accordance with ASTM Test Method E119: Standard Test Methods for Fire Tests of Building Construction and Materials.

2. The gypsum panel of claim 1, wherein the clay is present in the set gypsum core in an amount of from about 1 to about 10 weight percent.

3. The gypsum panel of claim 1, wherein the clay is uncalcined kaolin, calcined kaolin, fire clay, ball clay, or any combination thereof.

4. The gypsum panel of claim 1, wherein the clay is present in the set gypsum core in an amount of from about 30 to about 110 lb/msf.

5. The gypsum panel of claim 1, wherein the gypsum panel displays an average volume shrinkage of 5% or less or an average thickness thermal shrinkage of 20% or less at temperatures up to 927° C.

6. The gypsum panel of claim 1, wherein the set gypsum core further comprises a structural reinforcing material.

7. A building assembly comprising a plurality of the gypsum panels of claim 6, wherein the assembly passes one or more of the following standards:
2005 National Building Code of Canada and 2006 British Columbia Section 9.27.2.2, Item 1b;
ASTM E 2273-03 Standard Test Method for determining the Draining Efficiency of Exterior Insulating and Finish Systems (EIFS) Clad Wall Assemblies;
ASTM E 2925-17, Standard Specification for Manufactured Polymeric Drainage and Ventilation Materials; and
ASTM C1715-10, Standard Test Method for Evaluation of Water Leakage Performance of Masonry Wall Drainage Systems.

8. A method of making a gypsum panel of claim 7, comprising:
forming a first gypsum slurry by combining stucco, water, and a fire resistant additive, the fire resistant additive consisting essentially of clay;
setting the first gypsum slurry to form at least part of a core of the gypsum panel; and
associating a mat facing material with a surface of the set gypsum core,
wherein the clay is present in the set gypsum core in an amount of from about 0.5 to about 15 weight percent,
wherein the panel displays a fire rating not less than one hour when constructed as according to ASTM C1396 and tested in accordance with ASTM Test Method E119: Standard Test Methods for Fire Tests of Building Construction and Materials.

9. A gypsum panel, comprising:
a set gypsum core comprising clay in the absence of any non-clay fire resistant additives present in an amount effective to alter the fire resistance performance of the panel,
a mat facing material associated with a surface of the set gypsum core,
wherein the panel displays a fire rating not less than one hour when constructed as according to ASTM C1396 and tested in accordance with ASTM Test Method E119: Standard Test Methods for Fire Tests of Building Construction and Materials.

10. The gypsum panel of claim 9, wherein the clay is present in the gypsum core in an amount of from about 0.5 to about 15 weight percent.

11. The gypsum panel of claim 10, wherein the clay is uncalcined kaolin, calcined kaolin, fire clay, ball clay, or any combination thereof.

12. The gypsum panel of claim 9, wherein the gypsum panel displays an average volume shrinkage of 5% or less or an average thickness thermal shrinkage of 20% or less at temperatures up to 927° C.

13. The gypsum panel of claim 9, wherein the set gypsum core further comprises a structural reinforcing material.

14. A building assembly comprising a plurality of the gypsum panels of claim 13, wherein the assembly passes one or more of the following standards:
2005 National Building Code of Canada and 2006 British Columbia Section 9.27.2.2, Item 1b;
ASTM E 2273-03 Standard Test Method for determining the Draining Efficiency of Exterior Insulating and Finish Systems (EIFS) Clad Wall Assemblies;
ASTM E 2925-17, Standard Specification for Manufactured Polymeric Drainage and Ventilation Materials; and
ASTM C1715-10, Standard Test Method for Evaluation of Water Leakage Performance of Masonry Wall Drainage Systems.

15. A gypsum panel, including:
a set gypsum core including a non-intumescent fire resistant additive, the non-intumescent fire resistant additive comprising:
silica in an amount of at least 40% by weight of the non-intumescent fire resistant additive, and
ceramic flux agent in a total amount of more than 0% by weight and less than or equal to 5% by weight of the non-intumescent fire resistant additive; and
a mat facing material associated with a surface of the set gypsum core.

16. The gypsum panel of claim 15, wherein the gypsum panel displays a fire rating of not less than one hour when constructed as according to ASTM C1396 and tested in accordance with ASTM Test Method E119: Standard Test Methods for Fire Tests of Building Construction and Materials.

17. The gypsum panel of claim 16, wherein the non-intumescent fire resistant additive is present in the set gypsum core in an amount of from about 5 to about 110 lb/msf.

18. The gypsum panel of claim 16, wherein the non-intumescent fire resistant additive comprises S-glass fiber, E-glass fiber, or ball clay.

19. The gypsum panel of claim 18, wherein the gypsum panel displays an average thickness thermal shrinkage of 20% or less at temperatures up to 927° C.

20. The gypsum panel of claim 18, wherein the gypsum panel is substantially free of any intumescent fire resistant additive.

21. The gypsum panel of claim 15, wherein the ceramic flux agent comprises a compound of an element selected from the group consisting of lead, sodium, potassium, lithium, calcium, magnesium, barium, zinc, strontium, or manganese.

22. The gypsum panel of claim 15, wherein the set gypsum core further includes a structural reinforcing material.

23. A building assembly including a plurality of the gypsum panels of claim 22, wherein the assembly passes one or more of the following standards:
2005 National Building Code of Canada and 2006 British Columbia Section 9.27.2.2, Item 1b;
ASTM E 2273-03 Standard Test Method for determining the Draining Efficiency of Exterior Insulating and Finish Systems (EIFS) Clad Wall Assemblies;
ASTM E 2925-17, Standard Specification for Manufactured Polymeric Drainage and Ventilation Materials; and
ASTM C1715-10, Standard Test Method for Evaluation of Water Leakage Performance of Masonry Wall Drainage Systems.

24. A method of making a gypsum panel of claim 23, including:
forming a first gypsum slurry by combining stucco, water, and a non-intumescent fire resistant additive, the non-intumescent fire resistant additive comprising:
silica in an amount of at least 40% by weight of the non-intumescent fire resistant additive, and
ceramic flux agent in a total amount of more than 0% by weight and less than or equal to 5% by weight of the non-intumescent fire resistant additive;
setting the first gypsum slurry to form at least part of a core of the gypsum panel; and
associating a mat facing material with a surface of the set gypsum core.
